(19) United States
(12) Patent Application Publication
(10) Pub. No.: US 2026/0360012 A1
(43) Pub. Date: Nov. 12, 2026

(54) SPECTATOR-CENTRIC VISUAL MEDIA SYSTEMS AND METHODS

(71) Applicant: Transformative Optics Corporation, PORTLAND, OR (US)

(72) Inventor: Geoffrey B. Rhoads, West Linn, OR (US)

(73) Assignee: Transformative Optics Corporation, PORTLAND, OR (US)

(21) Appl. No.: 19/647,865

(22) Filed: Apr. 14, 2026

Related U.S. Application Data
(60) Provisional application No. 63/788,687, filed on Apr. 14, 2025.

(51) Int. Cl. G06T 7/80; G06T 5/10; G06T 5/40; G06T 5/70; G06T 5/92; G06T 7/11; G06V 10/25; G06V 10/26; G06V 10/82; G06V 40/10; G06V 40/16; H04N 7/18; H04N 23/90

(52) U.S. Cl. CPC G06T 7/80; G06T 5/10; G06T 5/40; G06T 5/70; G06T 5/92; G06T 7/11; G06V 10/25; G06V 10/26; G06V 10/82; G06V 40/103; G06V 40/161; H04N 7/183; H04N 23/90; G06T 2207/10016; G06T 2207/20052; G06T 2207/20084; G06T 2207/20182; G06T 2207/30201

(57) ABSTRACT

A spectator-centric imaging system built on an array camera infrastructure employs a unified seat-to-pixel coordinate data structure, populated by a single geometric calibration procedure that projects three-dimensional world coordinates of each arena seat through camera extrinsic and intrinsic matrices into the pixel space of the best-positioned imaging module. This shared data structure supports four coordinated applications: TeleSelfie, which delivers on-demand high-resolution patron portraits by submitting seat pan/tilt coordinates to the array camera's dual-processor serving pipeline; HiDyPop, which applies dynamic contrast enhancement to under-exposed spectator image regions as a post-interpolation transform within the serving pipeline without modifying stored data; Privacy, which obscures designated seat pixel regions in FPGA preprocessing hardware before any data is written to the aggregate scene memory; and Product Placement, which segments stored imagery into per-seat patches for geolocated recognition of branded merchandise. A GlowCap lens cap system comprising an LED array, diffuser, and attenuator enables calibration of camera sensors used in such systems.

### CROSS-REFERENCE TO RELATED APPLICATIONS

This patent application claims priority to U.S. Provisional Patent Application 63/788,687, filed Apr. 14, 2025.

This patent application is related to U.S. Provisional Application 63/761,969, filed Feb. 22, 2025, and U.S. Provisional Patent Application 63/740,985, filed Dec. 31, 2024, both of which are incorporated herein by reference in their entireties.

This application also incorporates by reference the following patent publications and applications in their entireties: U.S. Pat. No. 12,047,692; International Publication WO2024147826; U.S. patent application Ser. No. 19/013,418, filed Jan. 8, 2025 (published as US20250234104); and PCT/US23/73352, filed Sep. 1, 2023 (published as WO2024147826).

This application further incorporates by reference PCT Patent Application PCT/US25/61854, filed Dec. 31, 2025, entitled ARRAY CAMERA SYSTEMS AND METHODS, which describes array camera systems and methods for sports venue applications including non-uniform angular spacing of imaging modules, aggregate scene memory architectures, dual-processor serving pipelines, selective storage, and integrated imaging module configurations. Applicant expressly relies on and incorporates by reference all descriptions, figures, and numbered paragraphs of PCT/US25/61854.

This application further incorporates by reference U.S. patent application Ser. No. 19/234,706, filed Jun. 11, 2025, entitled ARRAY CAMERA METHODS AND ARRANGEMENTS, which claims priority to a provisional application filed Jun. 11, 2024, and which describes heterogeneous array camera architectures comprising imagers with distinct focal lengths, frame rates, and spectral channels—including color and monochromatic imagers—that collectively image across a three-dimensional view volume. The subject matter of U.S. application Ser. No. 19/234,706 is also described in Brady, Computational Imaging (MIT Press). Applicant expressly relies on and incorporates by reference all descriptions, figures, and numbered paragraphs of U.S. application Ser. No. 19/234,706.

### BACKGROUND

Arenas and stadiums feature contests between athletes, and presentation of other forms of public entertainment, in which the spotlight is on the headline talent—figuratively and literally—and not on the spectators. Video productions and broadcasting of such events similarly have a large bias in the focus and quality of video toward the talent as opposed to toward the spectators (although spectators sometimes are included in video coverage, such as the “kiss cam,” or coverage of fans during baseball's seventh inning stretch).

Array camera systems capable of capturing high-resolution imagery of entire sports venues are described in detail in our co-pending PCT Patent Application PCT/US25/61854 incorporated herein by reference. Such systems employ plural imaging modules fixedly joined in a common housing, each including a lens and an image sensor, and oriented to achieve consistent subject sampling resolution across a composite field of view. Captured imagery from all imaging modules is stored in an aggregate scene memory, from which a dual-processor pipeline—comprising a first processor (e.g., an FPGA) that generates floating-point pixel coordinates and a second processor (e.g., a GPU) that interpolates pixel values from memory—serves client-requested views at arbitrary pan, tilt, and zoom parameters in real time. These systems produce imagery at subject sampling resolutions of at least 1 pixel per 2 mm of subject extent across the entirety of a sports venue's playing field, and store pixel data in a circular buffer for instant replay together with compressed filter data for long-term storage.

This disclosure places video imaging of “the crowd” as of potential equal importance to that of imaging the talent, so that brand new forms of revenue generation become possible for professional teams, arena and stadium owners, professional leagues, and generally any and all business interests that arrange and execute the events. The array camera infrastructure described in PCT/US25/61854 provides, for the first time, a technical basis on which spectator-centric imaging applications can be built at scale: because every seat in the venue is imaged continuously at high resolution, and because each pixel of stored imagery maps to a precisely known angular coordinate in a unified geometric reference frame, applications that require per-seat pixel-level access—including patron portrait delivery, dynamic contrast enhancement, privacy protection, and product recognition—become technically feasible in ways not possible with conventional broadcast camera systems.

### SUMMARY

This disclosure describes four related spectator-centric applications of the array camera infrastructure: GlowCap (camera sensor calibration), HiDyPop (dynamic contrast enhancement of spectator imagery at serve time), TeleSelfie (on-demand patron portrait delivery), and Privacy (pre-storage obscuring of designated seat regions). A fifth application, Product Placement, enables geolocated recognition of branded merchandise worn by spectators. Each of these applications shares a common underlying data structure—a seat-to-pixel coordinate mapping—that is populated by a single geometric calibration procedure and reused across all five applications without modification.

According to one aspect, an apparatus includes a lens cap, a plurality of LEDs, a diffuser, and an attenuator integrated together in a common assembly, for calibration of arena camera sensors.

According to another aspect, a method includes identifying imagery desired by a client from a video memory that stores data for multiple image frames, determining metrics indicating contrast and image flatness for the identified imagery, and contrast-enhancing imagery corresponding to at least a sub-region of the identified imagery determined by reference to said contrast and image flatness metrics prior to delivery of said sub-region of imagery to the client, wherein said data for the multiple image frames stored in the video memory is not altered by said contrast enhancing but is left in an original state.

According to another aspect, a method includes receiving data indicating a particular seat in an arena ticketed to a particular patron, consulting a data structure to obtain at least first and second location coordinates indicating a location within a frame of pixels captured by a camera that corresponds to said seat, and providing to said particular patron an excerpt from an image frame captured by said camera that includes image data corresponding to said first and second location coordinates.

According to another aspect, a method includes receiving data indicating a particular seat in an arena ticketed to a particular patron, consulting a data structure to obtain at least first and second location coordinates indicating a location within a frame of pixels captured by a camera that corresponds to said seat, receiving imagery captured by said camera, and obscuring an excerpt of said imagery in a region corresponding to said first and second location coordinates while not obscuring other of the received imagery, prior to delivery of the camera imagery to a client.

According to another aspect, a method includes receiving imagery depicting spectators at an arena, segmenting the imagery into portions determined by reference to seat locations within the arena, and analyzing each of the portions to recognize at least one of clothing, hats, or glasses worn by spectators at said seat locations.

### BRIEF DESCRIPTION OF DRAWINGS

FIG. 1 shows the GlowCap lens cap system including a cover for a camera lens, an array of LEDs, and a diffuser.

FIG. 2 shows an illustrative camera mounted to a girder of an arena.

FIG. 3 shows a setup with a camera operated with its lens covered by the GlowCap assembly connected to a control module and a computer.

FIG. 4 shows an example of underexposed spectator imagery from a tennis tournament, illustrating the problem addressed by the HiDyPop feature.

FIG. 5 shows a schematic of an aggregate scene memory receiving data from plural imagers, as described in PCT/US25/61854.

FIG. 6A shows a wide shot with an enhancement region indicated by cross-hatch.

FIG. 6B shows the same scene after a user pans and zooms, with the enhancement region split and reshaped.

FIG. 6C shows a conceptual depiction of dynamic contrast enhancement applied to a zoomed-in excerpt of underexposed spectator imagery.

FIG. 7 shows a system diagram for the TeleSelfie feature, including a mobile phone, server, data structure, and video storage.

FIG. 7A shows an excerpt of the seat-to-pixel coordinate data structure mapping seat locators to best imager and pixel coordinates.

FIG. 8 shows an example TeleSelfie portrait excerpted from arena camera imagery.

FIG. 9 shows a system diagram for the Privacy feature, including imagers, an obscuring processor, video storage, a computer system, and a data structure.

FIG. 9A shows the seat-to-pixel coordinate data structure extended with a privacy flag column.

FIG. 10A shows a control point workflow used in seat-to-pixel coordinate calibration. FIG. 10B illustrates a process for mapping 3D seat coordinates in a venue to pixel space.

FIG. 11 shows a block diagram of the HiDyPop processing pipeline as a post-interpolation stage within the dual-processor serving system described in PCT/US25/61854.

FIG. 12 shows a flow diagram of the product recognition pipeline, illustrating segmentation, patch extraction, neural network inference, and geolocated brand analytics output.

### DETAILED DESCRIPTION

### GlowCap

A first aspect of the technology, which may be termed GlowCap, concerns calibration of stadium camera sensors, e.g., to enable dynamic range enhancement and improve color fidelity. The GlowCap system is used in conjunction with the array camera systems described in PCT/US25/61854 to calibrate the imaging modules mounted within sports venues.

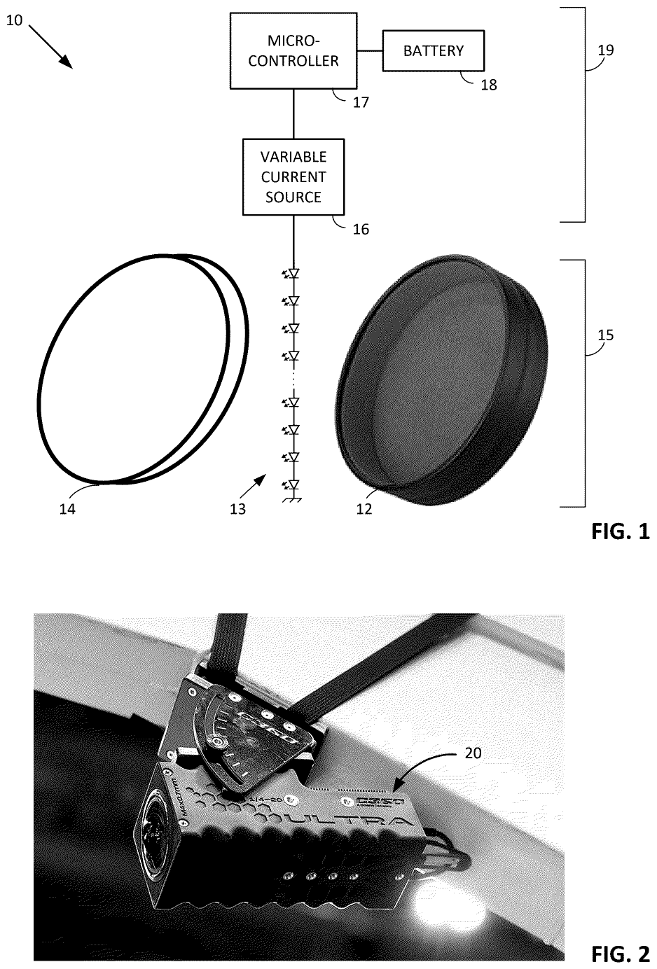

Referring to FIG. 1, a GlowCap is a lens cap system 10 that includes a cover 12 for a camera lens, an array 13 of LEDs, and a diffuser 14. These components are combined together into an assembly 15 having the shape of a light cap to cover the lens of a camera 20. An illustrative camera 20, the Cosm ULTRA, is shown in FIG. 2, mounted to a girder of an arena. The diffuser 14 may also include a filter that attenuates the LED light, e.g., by a factor of 100, 1000, 10,000 or more, on average, across the visible light spectrum (400-700 nm), before passage to the camera lens.

The LEDs 13, which may number a dozen or many more, are connected to a current source 16. The current source 16 is, in turn, connected to and controlled by a microcontroller 17, which is powered by a battery 18 or other power source.

The current source 16, microcontroller 17, and battery 18 can be integrated into the GlowCap assembly 15, or they can be provided in a separate control module 19 and connected to the GlowCap assembly 15 by a cable.

The LEDs 13 are shown in a line, but in practice they are distributed in two dimensions (e.g., in a grid array) to yield an approximately uniform spatial distribution of light. The LEDs 13 are typically all of the same color, but this is not essential. Commonly, “white” LEDs are used. Despite their irregular spectral curves, illumination from such LEDs (after diffusion) is useful in characterizing behavior of a camera image sensor by a set of calibration data. This data enables the camera imagery to be enhanced, e.g., by permitting the imagery to be increased in dynamic range (such as from 12-bits to 14-bits), and to effect noise reduction.

Particular techniques for achieving such improvements in camera performance are detailed in our earlier patent applications, including U.S. application Ser. No. 19/013,418, filed Jan. 8, 2025, and international application PCT/US23/73352 (published as WO2024147826). Those methods can be practiced using the GlowCap system 10.

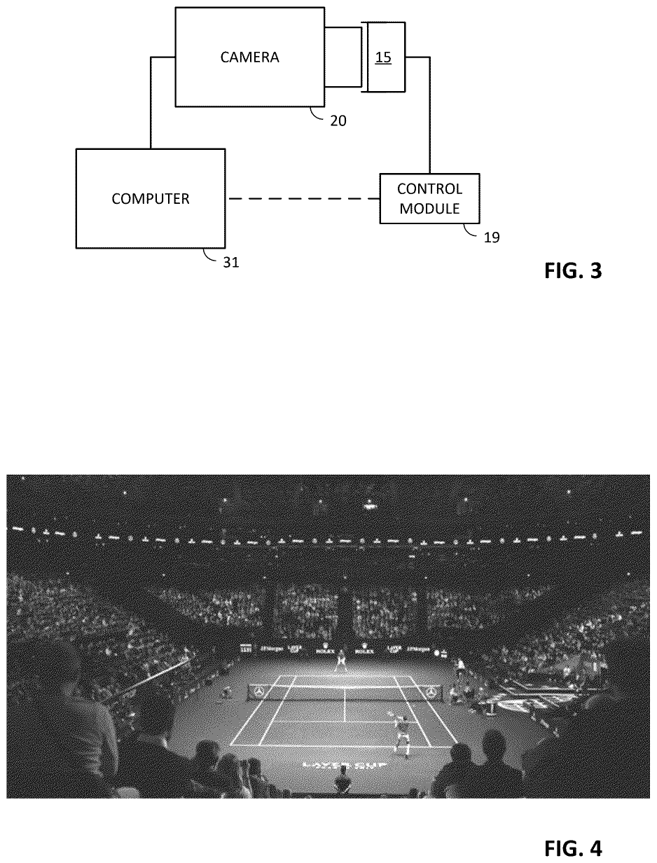

FIG. 3 illustrates a particular set-up. The camera 20 is operated with its lens covered by the GlowCap assembly 15, so the only illumination the camera 20 senses is the diffused light from the LEDs 13. A computer 31 is provided to analyze frames of imagery captured by the camera 20, in accordance with the methods detailed in the just-cited patent applications (e.g., termed Chromabath and ShadowChrome processing in those documents).

The microcontroller 17 in control module 19 controls the current source 16, e.g., so as to provide a first current level for an interval of one to five seconds, followed by a second, higher current level for another such interval, optionally followed by successively higher current levels for further such intervals.

The camera 20 is meanwhile capturing frames of imagery at video rates, e.g., 60 to 500 frames per second. At each level of illumination (including at an initial level of no illumination, with no current passing through the LEDs 13), the computer 31 receives hundreds of frames of imagery from the camera 20. The computer 31 applies the noted procedures to the collected image frames to generate calibration data for that camera 20.

In some embodiments, no signals are exchanged between control module 19 and the computer 31; there is no data link. The computer 31 senses the step shift across all pixel values when the control module 19 increases the LED current from one value to the next, to enable frames gathered under a given illumination condition to be grouped together.

If desired, the control module 19 can initiate the illumination sequence by a series of light pulses that encodes or indicates metadata relevant to the calibration procedure, such as the serial number of the GlowCap assembly 15, and a code indicating which of possibly several different illumination sequences the assembly is about to provide. A corresponding decoder software routine in the computer 31 extracts this metadata from the light pulses. In other arrangements, such information may be conveyed between the GlowCap assembly 15 and the computer 31 by a wired or wireless (e.g., WiFi) connection.

### Seat-to-Pixel Coordinate Infrastructure

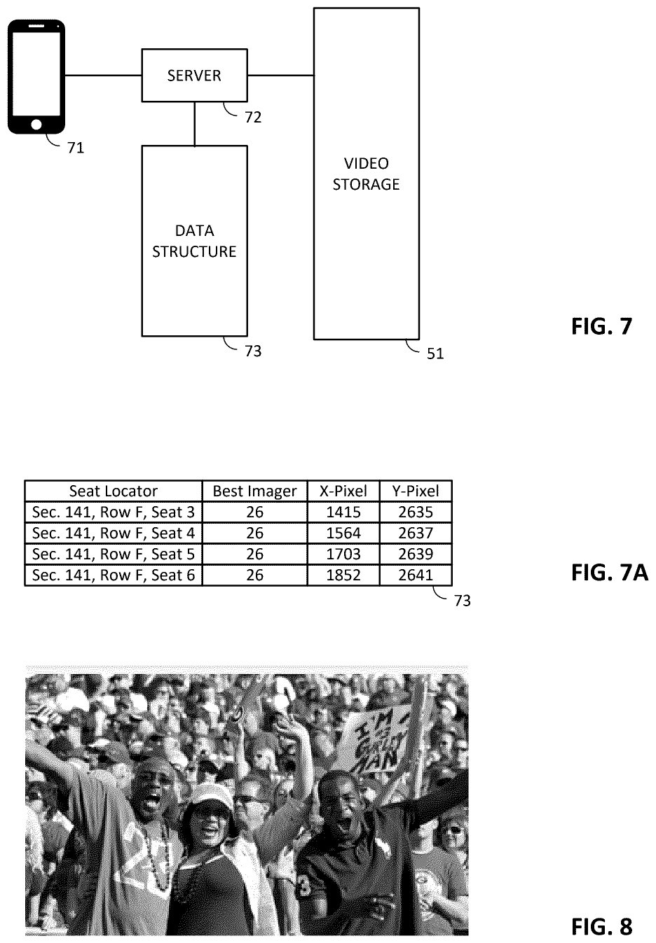

Before describing the HiDyPop, TeleSelfie, Privacy, and Product Placement features in detail, it is useful to describe the seat-to-pixel coordinate data structure that underlies all four of these features, since they share a common calibration infrastructure. HiDyPop makes use of data structure 73 (FIG. 7A), described in this section, to seed enhancement candidate regions with known seat locations.

Each seat in an arena has a given locator, e.g., Section 141, Row F, Seat 5. This locator data is known for each spectator who has purchased a ticket to an event. The array camera system described in PCT/US25/61854 images each such seat at high resolution from one or more of its imaging modules. To enable per-seat pixel-level access, a data structure maps each seat locator to the pixel coordinates of that seat within the frame of the best-positioned imager.

### Calibration Procedure

The seat-to-pixel coordinate data structure is populated by the following calibration procedure, which is performed once per venue installation (and updated as needed when camera positions change):

For each seat in the venue identified by its seat locator (section, row, seat number):
Step 1—Load the known three-dimensional world coordinates [X, Y, Z] of the seat centroid. These coordinates may be obtained from the venue's architectural CAD model, from a LiDAR survey of the venue interior, or from a prior photogrammetric survey. The use of photogrammetric calibration methods, such as those described in Zhang, “A flexible new technique for camera calibration,” IEEE Transactions on Pattern Analysis and Machine Intelligence, 22(11), pp. 1330-1334, 2000, may be employed to refine the mapping between world coordinates and image coordinates.
Step 2—For each imaging module i in the array camera system, project the world coordinates [X, Y, Z] through the imager's extrinsic matrix [R_i|t_i] (which encodes the rotation and translation of imager i relative to the world coordinate frame) and intrinsic matrix K_i (which encodes the focal length and principal point of imager i's lens) to yield projected pixel coordinates [u_i, v_i] within the image frame of imager i. This projection follows the standard pinhole camera model: [u_i, v_i, 1]\hat{ }T=K_i[R_i|t_i][X, Y, Z, 1]\hat{ }T.
Step 3—Convert the projected pixel coordinates [u_i, v_i] to angular coordinates (pan_i, tilt_i) in the unified bullseye coordinate system of the camera head, as described in PCT/US25/61854, using the angular field-of-view parameters of imager i.
Step 4—Select the “best imager” for each seat as the imager i* that maximizes the product of (a) the subject sampling resolution at the seat's distance from imager i, measured in pixels per millimeter of subject extent, and (b) a binary occlusion flag indicating whether the seat's projection falls within the valid (unvignetted) pixel area of imager i's sensor. Where multiple imagers have equivalent resolution and occlusion status, preference is given to the imager whose boresight direction most closely aligns with the vector from the imager to the seat, minimizing off-axis lens distortion.
Step 5—Store the following record in data structure 73: {seat_locator, best_imager_id, pan_coordinate, tilt_coordinate, pixel_bounding_box [u_min, u_max, v_min, v_max]}, where the pixel bounding box defines a rectangular region in imager i*'s pixel space that encompasses the seat and a contextually useful margin around it (e.g., a region sufficient to include a seated adult patron and one adjacent seat on each side).

An excerpt of data structure 73 is shown in FIG. 7A. The data structure is stored in a computer server 72 serving the venue. The calibration procedure is performed before each season or after any modification to camera positions, and the resulting data structure is shared across all applications described herein—TeleSelfie, HiDyPop region seeding, Privacy obscuring, and Product Placement segmentation—without recomputation.

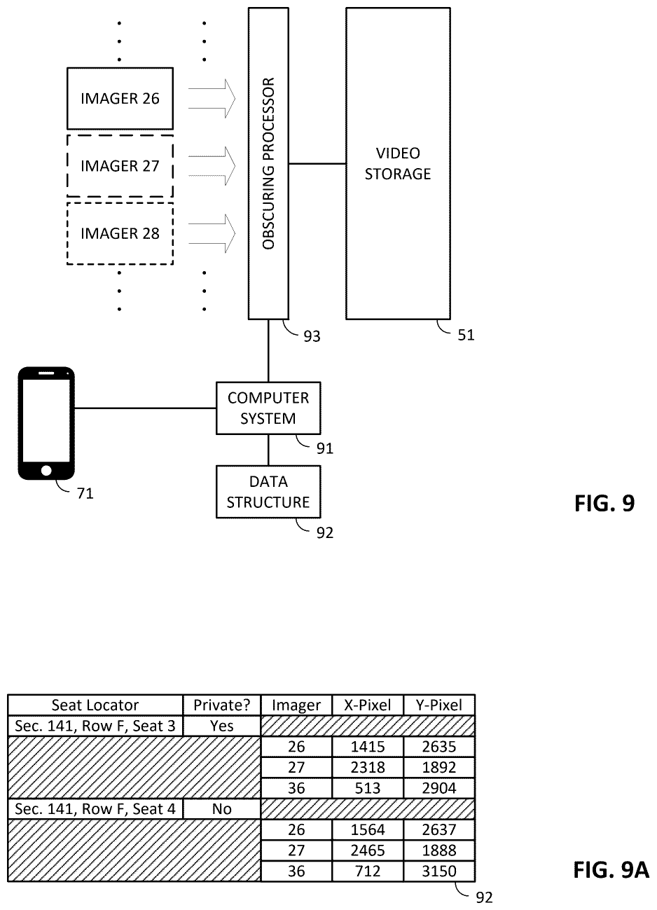

In some embodiments, the calibration procedure further computes, for each seat, a list of all imagers (not only the best imager) whose fields of view encompass that seat, together with the corresponding pixel coordinates in each such imager. This extended record is stored in a supplementary data structure 92 (FIG. 9A) used by the Privacy feature.

### HiDyPop

To permit capture of the fast motion of many sporting activities without motion blur, the playing area is typically brightly illuminated. Illumination of spectator seating, while plenty bright for the spectators' purposes, is relatively dim by comparison. When imagery depicting the playing area also depicts some spectator seating, the spectator seating imagery is commonly under-exposed. FIG. 4 gives an example, taken from video of a tennis tournament.

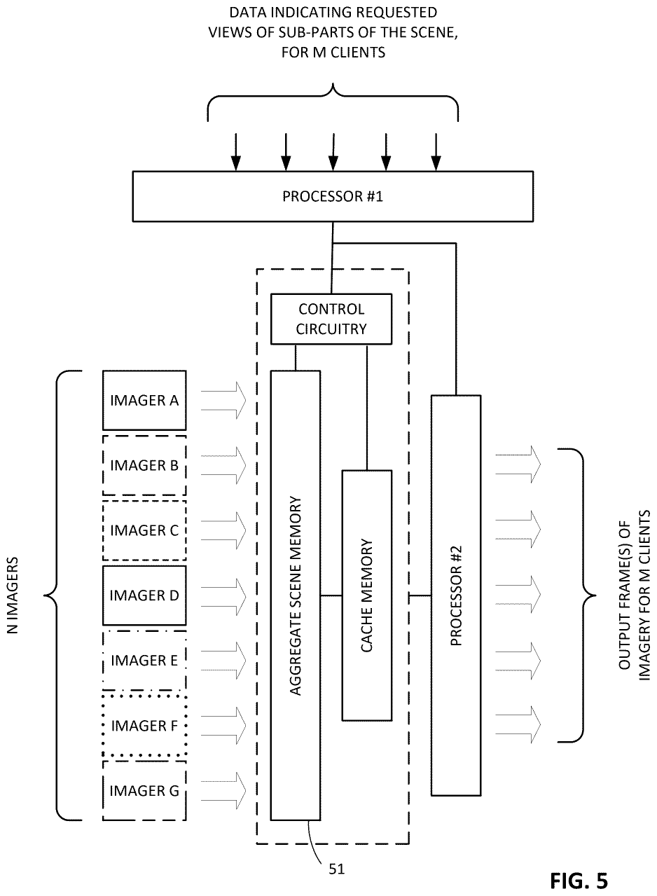

This exposure challenge becomes more pronounced with array camera systems that capture a hundred or more megapixels each frame interval by use of multiple imagers. As described in PCT/US25/61854, the captured imagery is stored in an aggregate scene memory 51 that can be queried by multiple different viewing clients to obtain video streams focused on multiple different subjects at multiple different zoom levels. Since it is unknown, at the time of image capture, which of the collected pixels will be served to clients, optimization of exposure at the time of image capture is not practical. A figure from applicant's patent application PCT/US25/61854 is reproduced as FIG. 5 and shows the aggregate scene memory 51 that provides storage for video data received from the stadium imagers.

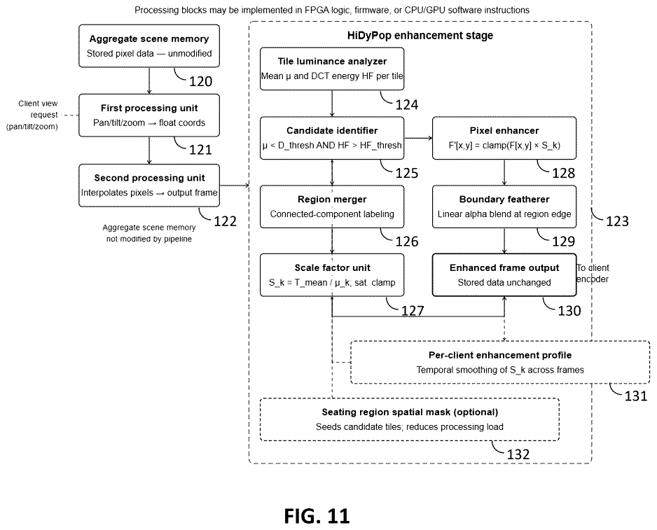

In accordance with this aspect of the technology, the HiDyPop feature operates within the serving pipeline of the array camera system described in PCT/US25/61854. Specifically, the dual-processor serving architecture described therein (see FIG. 11)—in which a first processing unit 121 (e.g., an FPGA) generates floating-point angular coordinates for each output pixel of a client-requested view, and a second processing unit 122 (e.g., a GPU) interpolates pixel values from the aggregate scene memory 51 to compose the output frame—provides a natural insertion point for dynamic contrast enhancement. The HiDyPop enhancement stage 123 (FIG. 11) is applied by the second processing unit 122 as a post-interpolation, pre-delivery transform to the output frame, after interpolated pixel values have been assembled but before the output frame is delivered to the client. The aggregate scene memory 51 is not modified; only the served output is enhanced.

In a particular embodiment, served image frames are analyzed for one or more regions of poor contrast, and contrast enhancement is applied only to such region(s). The contrast enhancement can comprise simply stretching the dynamic range of pixels within the region. For example, if a region has an average brightness of 20 on an 8-bit scale (i.e., pixel values of 0-255), all pixels in the region may be increased by a common factor (e.g., 2-8) to increase the average brightness. This can result in some pixels becoming saturated (e.g., nominally having values greater than 255). If more than a threshold percentage of pixels in the region become saturated (e.g., more than 5%, 10% or 20%), the scale factor is reduced until the threshold is no longer exceeded. (Normally, 10-, 12- or 14-bit imagery is produced in arena camera systems; 8-bit is referenced for expository convenience.)

The contrast enhancement operation can also comprise an HDR (high dynamic range) process, as is known in the prior art of full-frame enhancement of still imagery.

In some embodiments, selection of a region for enhancement depends on criteria in addition to low contrast. For example, the dark region may be checked for the presence of a threshold degree of high frequency image content. This safeguards against enhancement of features in the imagery that should remain dark—such as the flat black wall in the back of the tennis stadium depicted in FIG. 4.

### HiDyPop Processing Algorithm

The following algorithm is performed by the second processing unit 122 on each output frame, for each client stream, as part of the serving pipeline. The processing blocks of the HiDyPop enhancement stage 123 are shown in FIG. 11 and may be implemented in any combination of FPGA logic, firmware, or CPU/GPU software instructions.
Step 1—Tile luminance analyzer 124. The interpolated output frame F of dimensions W×H pixels is divided into non-overlapping tiles of size T_w×T_h pixels (e.g., 64×64 pixels). For each tile, the following metrics are computed: (a) mean luminance μ, computed as the arithmetic mean of luma values of all pixels within the tile; and (b) high-frequency energy HF, computed as the sum of squared DCT coefficients at spatial frequencies above a threshold f_min (e.g., the sum of squared DCT coefficients excluding the 3×3 block of DC and near-DC coefficients in an 8×8 DCT). In some embodiments, the luma channel of a 4:2:0 chroma-subsampled representation of the stored frame—maintained in the pyramidal encoding system described in PCT/US25/61854—may be used for fast pre-screening of tiles before fetching full-resolution data.
Step 2—Candidate identifier 125. A tile is flagged as an enhancement candidate if and only if: (a) μ is less than a darkness threshold D_thresh (e.g., D_thresh=40 on an 8-bit scale), indicating under-exposure; AND (b) HF is greater than a texture threshold HF_thresh, indicating the presence of real image content rather than a featureless dark region. This condition guards against erroneous enhancement of legitimately dark regions, such as the flat black wall in the background of the tennis stadium depicted in FIG. 4. In some embodiments, the set of tiles eligible for enhancement candidate testing is seeded by the seating region spatial mask 132 that identifies spectator seating regions in the array camera system's field of view, as described in PCT/US25/61854 in connection with the selective storage feature.
Step 3—Region merger 126. Spatially contiguous enhancement candidate tiles are merged into enhancement regions R_k using connected-component labeling. For each enhancement region R_k, a bounding box and pixel mask are computed.
Step 4—Scale factor unit 127. For each enhancement region R_k with mean luminance μ_k, a scale factor S_k is computed as S_k=T_mean/μ_k, where T_mean is a target mean luminance (e.g., T_mean=100 on an 8-bit scale). The scale factor is then clamped: if application of S_k would cause more than a saturation threshold percentage SAT_thresh (e.g., 10%) of pixels in R_k to exceed the maximum pixel value, S_k is reduced iteratively until the saturation percentage is at or below SAT_thresh.
Step 5—Pixel enhancer 128. For each pixel [x, y] within enhancement region R_k, the enhanced pixel value is computed as F′[x, y]=clamp(F[x, y]×S_k, 0, max_val). In some embodiments, a local tone mapping operation such as Contrast Limited Adaptive Histogram Equalization (CLAHE) may be applied within R_k instead of or in addition to linear scaling.
Step 6—Boundary featherer 129. At the boundary of each enhancement region R_k, the enhanced frame F′ and the original frame F are blended over a feathering band of width B pixels (e.g., B=8 pixels) using a linear alpha transition.
Step 7—Enhanced frame output 130. The enhanced frame is delivered to the client encoder. The aggregate scene memory 51 is not modified.

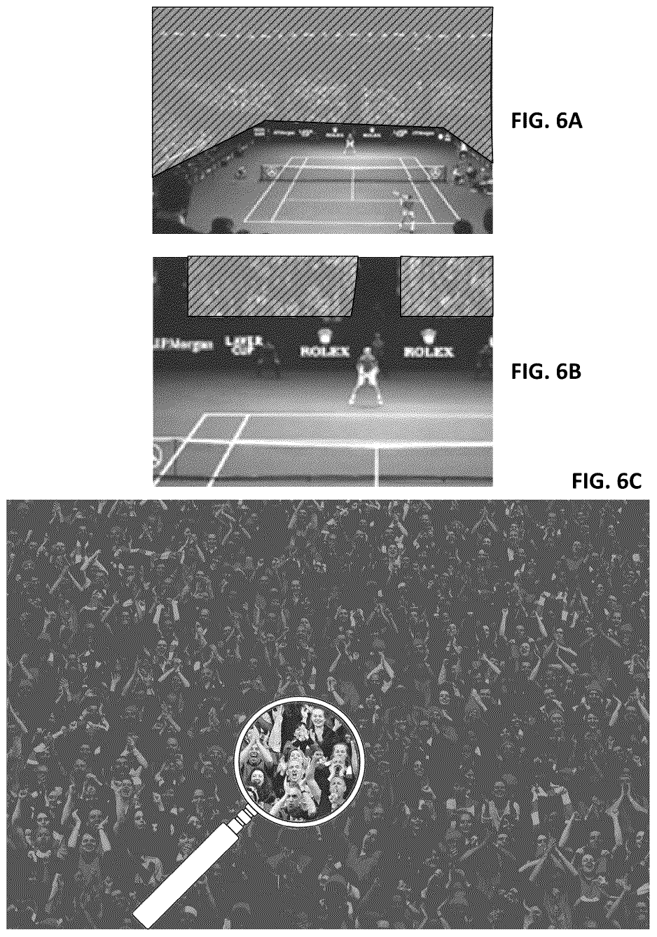

As a client's requested video stream pans and zooms in and out of the image data stored in the aggregate scene memory 51, the size and shape of the enhanced region of the video frame typically changes (FIGS. 6A and 6B). The enhancement regions are recomputed each frame from the current output pixel set, ensuring that the enhancement tracks the client's virtual camera position. FIG. 6C shows a conceptual depiction of dynamic contrast enhancement applied as a client zooms into an image data set depicting underexposed spectators.

We term this feature HiDyPop because it causes previously-obscure regions of imagery to pop into better visibility as the client streams imagery from the aggregate scene memory 51.

In some embodiments, a per-client enhancement profile 131 is maintained that records the history of scale factors S_k applied to that client's stream. Temporal smoothing of S_k across consecutive frames suppresses abrupt changes in enhancement strength when the client's virtual camera transitions between bright and dark scene regions.

In some embodiments, the enhancement regions R_k identified by the region merger 126 are seeded directly from the pixel bounding boxes stored in data structure 73 for known spectator seat locations, rather than being derived solely from per-tile luminance and texture statistics. In such embodiments, the candidate identifier 125 applies its darkness and texture threshold criteria only to tiles that fall within seat bounding boxes retrieved from data structure 73, restricting enhancement analysis to regions of the output frame that are known to correspond to occupied spectator seats. This approach reuses the seat-to-pixel coordinate infrastructure described in connection with TeleSelfie and Product Placement, and reduces processing load by eliminating tile analysis for non-seat regions of the frame. Because data structure 73 is shared across all applications without recomputation, the seating-region seeding of enhancement candidates adds no calibration overhead.

Because the enhancement stage 123 operates entirely within the serving pipeline and does not modify the aggregate scene memory 51, the same stored frame may be served simultaneously to multiple clients with different enhancement states. For example, a first client such as a suite viewer requesting spectator imagery may receive an output frame with enhancement applied by the enhancement stage 123, while a second client such as a broadcast producer requesting a full-field view receives an output frame from the same stored data without enhancement, both served concurrently by the dual-processor pipeline comprising first processing unit 121 and second processing unit 122. This per-client independence of enhancement state is a direct consequence of the architectural separation between the aggregate scene memory 51, which stores unmodified pixel data, and the serving pipeline, which applies enhancement as a post-interpolation transform specific to each client's requested view.

In some embodiments, the system precomputes enhancement parameters for known spectator seating zones based on the arena's photometric model, storing them in a lookup table keyed by zone identifier and time of day. When a client requests imagery of a known seating zone, parameters from this table may be used to initialize the enhancement computation, reducing the number of iterations required to converge on an appropriate scale factor.

HiDyPop technology, as described above, is often used to enhance the contrast of TeleSelfie imagery, since spectators are commonly underexposed in captured imagery.

### TeleSelfie

Another aspect of the technology enables spectators to obtain portraits (or video clips) of themselves or their groups, excerpted from captured arena imagery.

Referring to FIG. 7, to request a selfie, a spectator uses their mobile phone 71 to open an app that supports this functionality. The app may be, e.g., the MLB iPhone app for a spectator at a baseball game, or the Ticketmaster app for an attendee at a concert. The app may already know the spectator's seat, e.g., from a ticketing function that is also served by the app. Or the app can permit the spectator to scan a barcode on a printed ticket to obtain the locator data.

A computer server 72 serving the venue includes a lookup table or other data structure 73 that identifies, for each seat locator, a corresponding camera imager within the venue that has a field of view that depicts the seat (or that best-depicts the seat, if the seat is in the field of view of several imagers). The data structure 73 further identifies a pair of pixel coordinates, within the corresponding camera imager frame, that corresponds to that seat locator. An excerpt from data structure 73 is shown in FIG. 7A.

### Venue-Staff App Calibration Workflow

The precise and exact mapping between seats and the arena or stadium coordinate system warrants further description. The jostling of a camera head by a technician in routine maintenance is but one real-world challenge in making sure that when a spectator wishes to fire up these venue-supported services, they see themselves and not their neighbors seven seats away. In one embodiment, a mapping support application can be built targeting venue staff 100 as users. Four hours prior to a game, or even days before a game if conditions remain stable, a venue staffer 100 is tasked with spending approximately 30 minutes walking up and down aisles with this specially designed venue mapping app 101 on their smartphone. They proceed toward a total of 50 to 100 control points in and around the venue and press simple section number, row number, and seat number buttons when they are physically standing in these locations. The venue mapping app 101 may present a user interface that allows them to tap on visual seat icons rather than typing alphanumeric codes. Each time a button is pressed, the arena camera system 102 identifies which cameras are viewing the venue staffer 100 and logs the pixel locations of the staffer 100 in each such camera's frame as a pixel location log 104. In some cases the staffer 100 may be asked to sit down as well as stand, so that a given seat's occupied and standing human figure positions can be finely logged in the seat locator record 103. There is no need to sample all seats in the venue: a fairly coarse sampling, along with a solid three-dimensional map of the venue's seating geometry, will suffice to establish control points 105 that calibrate all seats through interpolation. Similar precise mapping calibration procedures can also be accomplished without venue staffers. Simple automated recognition of section markers, aisle identifiers, row numbers, and seat numbers visible in the captured imagery can perform the same function. In an evolutionary sequence, a venue-staff-app approach can kick-start such precision maps, with later automation, as is typical of the maturation of such systems.

The following steps describe in further detail how the control points 105 collected by the venue mapping app 101 are used to populate and maintain data structure 73. First, the staffer's 100 smartphone records, for each control point visit, a timestamp and a pressed seat locator record 103 (section, row, seat number). The arena camera system 102 simultaneously identifies, across all imaging modules whose fields of view encompass the staffer's position, the pixel location log 104 of the staffer 100 in each such module's current frame. This identification may use a person-detection algorithm applied to the live video feed, or may use the staffer's smartphone GPS coordinates in combination with a pre-existing three-dimensional model of the venue to compute approximate projected pixel coordinates 112, which are then refined by local template matching in the image. Second, for each control point, the system stores a record associating the seat locator record 103 with the identified pixel location log 104 in each relevant imager. Third, these sparse control points 113 are used to fit a smooth geometric mapping function 114—for example, a piecewise bilinear interpolation over the seating grid, or a low-order polynomial warping function—that predicts pixel coordinates for any seat in the venue from its section, row, and seat number, including seats not directly visited during the calibration walk. Fourth, this fitted mapping function 114 is evaluated at every seat in the venue to populate data structure 73 with a complete set of seat-to-pixel coordinate records. Fifth, verification and recalibration block 115 compares predicted pixel coordinates at a held-out subset of visited control points 105 against the measured coordinates; where discrepancies exceed a threshold (e.g., more than 10 pixels of error), the mapping function 114 is re-fitted with additional control points 105 or with a higher-order function. The camera system may additionally perform automated recalibration on an ongoing basis by detecting known fixed reference points in the venue—such as seat number placards, aisle markers, or painted section designations visible in the captured imagery—and using their known physical coordinates to detect and correct for drift in the camera positions over time.

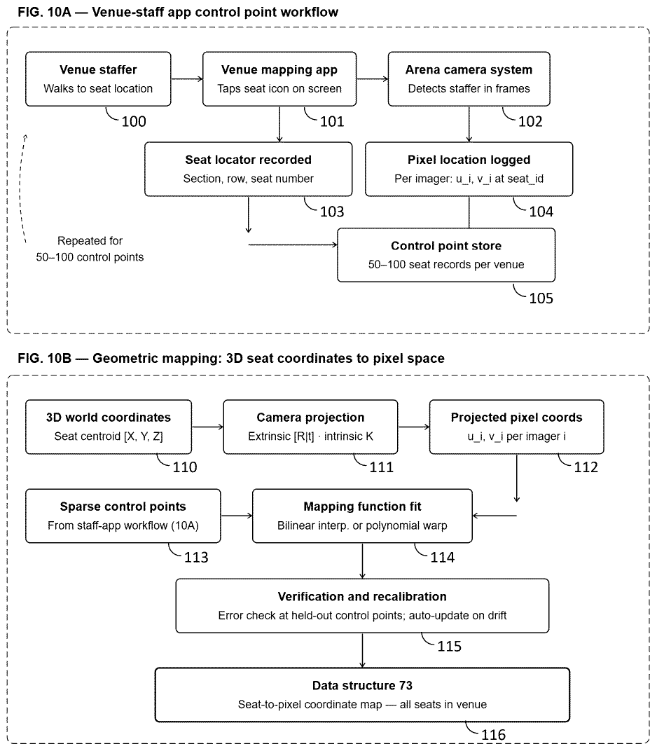

Referring again to FIG. 10B, in some embodiments the mapping function 114 is further informed by projecting known three-dimensional world coordinates 110 of seat centroids through the camera projection block 111 (comprising the extrinsic matrix [R|t] and intrinsic matrix K of each imager) to yield projected pixel coordinates 112 for each seat in each imager. These projected pixel coordinates 112 supplement the sparse control points 113 from the staff-app workflow to improve the accuracy of the mapping function 114, particularly for seats that were not directly visited by the venue staffer 100. The final output of both calibration paths is data structure 73 (116), which stores a complete seat-to-pixel coordinate map for all seats in the venue.

When the selfie app is invoked (and possibly after payment of a fee), it requests selfie imagery from the aggregate scene memory 51 for the corresponding camera imager. This imagery is centered on the spectator's seat pixel coordinates from data structure 73 and is initially delivered at a default zoom level and at a relatively low resolution. A control in the app enables the spectator to zoom in or zoom out of the preview imagery, e.g., so as to include others in the spectator's group. When the spectator has obtained a desired zoom level in the preview imagery, they alert other members in their group to smile or cheer, and touch a Snap button on the app user interface. A full-resolution frame of imagery is then extracted from the aggregate scene memory 51 and served to the spectator through the app. The full-resolution selfie imagery may also be sent to the spectator's email address, or posted to the user's social media account. The same arrangement can permit delivery of video clips of user-selectable length (e.g., 3 seconds or 10 seconds).

Souvenir selfies of a memorable event, such as the selfie shown in FIG. 8, can thereby be obtained from an arena camera system.

### TeleSelfie Serving Pipeline

The TeleSelfie serving pipeline exploits the dual-processor architecture of the array camera system described in PCT/US25/61854. When a TeleSelfie request is received from a patron's mobile phone 71, the following steps are performed:
Step 1—Authentication and Lookup. The patron's seat locator is authenticated via the ticketing system 142. The computer server 72 retrieves the record {best_imager_id, pan, tilt, pixel_bounding_box} from data structure 73 for the patron's seat.
Step 2—Initial Preview Delivery. The pan and tilt coordinates, together with a default zoom value, are submitted to the first processing unit 121 of the serving pipeline. The first processing unit 121 generates floating-point coordinates for the output pixels of the preview frame, resolves memory addresses in aggregate scene memory 51, and fetches pixel clusters from memory. The second processing unit 122 interpolates pixel values to compose the preview frame. HiDyPop enhancement stage 123 is applied to the preview frame prior to delivery to the patron's mobile phone 71. The preview is delivered at reduced resolution (e.g., 720p) to minimize latency.
Step 3—User Zoom Adjustment. The app presents the preview to the patron with a zoom control. As the patron adjusts the zoom, updated pan/tilt/zoom parameters are submitted to the first processing unit 121 and new preview frames are delivered.
Step 4—Full-Resolution Capture. When the patron touches the Snap button, the serving pipeline fetches a full-resolution frame from aggregate scene memory 51 at the patron-selected zoom level. The full-resolution frame is encoded and delivered to the patron through the app, optionally also sent to the patron's email address or posted to a social media account.
Step 5—Video Clip Delivery. The same arrangement permits delivery of video clips of user-selectable length by repeating the per-frame serving process across a sequence of consecutive frames retrieved from aggregate scene memory 51.

### Multi-Imager and Group TeleSelfie

For seats that fall within the overlapping fields of view of two or more imaging modules, the TeleSelfie excerpt may be synthesized by the weighted blending interpolation method described in PCT/US25/61854, weighting each imager's contribution by its subject sampling resolution at the seat's distance. In some embodiments, a Group TeleSelfie is provided by clustering the seat coordinates of an arbitrary user-defined group into a composite bounding box, selecting the imager whose field of view best encompasses the group, and delivering the group portrait simultaneously to the mobile phones 71 of all group members. The group portrait delivery exploits the multi-client serving architecture of the array camera system described in PCT/US25/61854, in which the serving pipeline is capable of simultaneously delivering M≥2 different output streams to M≥2 clients from the same stored data in aggregate scene memory 51. In the Group TeleSelfie context, all group members' mobile phones 71 constitute M concurrent clients receiving the same pan/tilt/zoom excerpt in a single serving pipeline invocation, without requiring separate memory fetches for each recipient.

### Privacy

It is increasingly common for broadcast coverage of sporting events to include occasional camera shots of celebrities in the audience. The celebrities are typically identified manually. However, image data captured by imagers in an arena camera system can be segmented to extract facial regions, and these excerpts can be presented to a neural network facial recognition system that has been trained to recognize a large group of celebrities. While such publicity is welcomed by many celebrities, some celebrities and some other spectators may prefer that their faces not be visible in imagery captured by arena camera systems. Such privacy is provided by a further aspect of the technology.

If a spectator desires to remain private, they can so-indicate by an app, such as one of the apps noted in the previous section. The app transmits their seat locator data to a computer system 91 (FIG. 9) that services privacy requests for the arena. This computer system 91 can access a data structure 92 that identifies, for each seat location in the arena, the imagers whose fields of view encompass the seat, and the pixel coordinates corresponding to the seat within the image frame captured by each of these imagers. A flag bit can be set within data structure 92 to indicate that the seat's occupant desires privacy. Such a data structure 92 is conceptually illustrated in FIG. 9A, showing two seats and data identifying the three cameras that depict these seats within their respective fields of view, as well as the pixel coordinates associated with the seats. The system thereby maintains a listing of seats and image locations that are designated as private for the current sporting or other event. The privacy flag is reset to a not-private default state at the start of each new event and must be re-asserted by the patron for each event, providing a clean per-event consent model consistent with applicable privacy regulations.

### Privacy Obscuring Pipeline

In accordance with the array camera system architecture described in PCT/US25/61854, image data from each imaging module passes through a preprocessing stage implemented in the FPGA SOM (e.g., the Zynq UltraScale+ FPGA SOM described therein) before being written to aggregate scene memory 51. The privacy obscuring operation performed by obscuring processor 93 is inserted into this FPGA preprocessing pipeline, so that obscuring is performed in programmable hardware before any pixel is written to any memory. Because the obscuring is performed at this stage, no unobscured version of a private seat region exists in any persistent storage medium, directly satisfying the privacy by design principle of applicable privacy regulations.

The FPGA SOM maintains, in a dedicated set of registers, the pixel bounding boxes for all seats currently flagged as private in data structure 92, loaded from the computer system 91 before the event begins. For each imager i and each private seat's bounding box registered for that imager, the following obscuring operation is performed on each captured frame before it is written to the aggregate scene memory 51:
Option A—Gaussian Blur. A Gaussian blur with kernel radius r (e.g., r=15 pixels) is applied to all pixels within the seat's bounding box [u_min, u_max, v_min, v_max] in imager i's frame. The blur kernel radius applied in each imager is scaled in proportion to that imager's subject sampling resolution at the seat's distance—for example, an imager with a longer focal length and higher pixel-per-mm resolution at the seat's distance receives a larger blur kernel radius than an imager with a shorter focal length and lower resolution at that distance—so that the obscured region is perceptually consistent across all imagers depicting the same seat even if those imagers have different focal lengths and subject resolutions, as arises in the multi-focal-length array camera configurations described in PCT/US25/61854.
Option B—Region Replacement. The pixel region within the bounding box is replaced with a solid fill value (e.g., a neutral gray approximating an average skin-tone value) for stronger anonymization when required.
Option C—Noise Addition. Random noise is added to pixel values within the bounding box, destroying facial recognition features while preserving the visual impression of a person's presence in the seat.

All downstream uses of the stored video—including TeleSelfie delivery, broadcast streaming, and Product Placement recognition—automatically respect the privacy preference because the obscured version is the only version stored.

### Facial-Recognition-Augmented Privacy

In some embodiments, a lightweight face detector (e.g., a RetinaFace-class neural network, executable on the FPGA SOM or a Jetson GPU peripheral) processes each captured frame to detect facial regions in addition to the registered seat bounding boxes from data structure 92. If a detected facial region falls within or near the registered bounding box of a privacy-flagged seat, obscuring is applied to the detected face region even if it is slightly displaced from the registered bounding box centroid (e.g., due to the patron leaning forward or turning in their seat).

In some embodiments, a league-wide or venue-wide policy flag may cause facial-recognition-based obscuring to be applied to all detected faces in spectator seating regions independent of individual patron opt-in, enabling compliance with jurisdictions where collection of biometric imagery without individual consent is restricted. Such a policy flag may be stored as a system-level configuration parameter separate from the per-seat privacy flags in data structure 92, or may be implemented as a venue-wide flag entry within data structure 92 itself that causes the obscuring processor 93 to treat all seat bounding boxes as privacy-flagged regardless of their individual flag states. In either implementation, the obscuring processor 93 applies the same pixel-region obscuring operations described above to all seats within the spectator seating mask.

By such arrangement, video broadcast from an event, as well as other video and imagery sourced from the collected camera data including TeleSelfies, is automatically scrubbed of recognizable faces of persons who take advantage of the privacy feature.

### Product Placement

In accordance with a further aspect of the technology, imagery captured by arena cameras is analyzed to identify particular products depicted in the imagery.

In a particular embodiment, captured imagery is segmented into patches corresponding to individual arena seats. Each patch is input to an object recognition and segmentation engine 145 that has been trained to recognize various items of clothing, hats, sunglasses, and other products. A survey can thereby be conducted to inventory recognizable branded items found in the arena.

Consumer brands can participate in this undertaking by providing stock imagery depicting products in their catalog, with which the recognition engine 145 can be trained. Nike, Adidas, and Ray-Ban, for example, may provide training imagery, and the resultant system will then be adept at identifying such product offerings in the stadium. Training imagery for products of non-participating brands can be obtained from other sources.

### Segmentation Via Shared Coordinate Infrastructure

The seat-to-pixel coordinate data structure 73 populated during the TeleSelfie calibration procedure directly provides per-seat image patch boundaries for the per-seat patch extractor 143. For each occupied seat, the pixel bounding box stored in data structure 73 defines the image region to be extracted and analyzed. This reuse of the coordinate infrastructure is a key feature of the present system: the cost of seat-wise segmentation—the foundational step enabling geolocated product analytics—is zero once TeleSelfie calibration has been performed. It is worth noting that this precise mapping of pixels to exact seats is of tremendous commercial value to brands utilizing these product placement services. Opt-in reward systems for spectators who also agree to allow product companies to gain access to basic demographics (age, sex, sports preferences, etc.) further increase the value of visually discovered and identified products. This precise mapping can further be combined with facial recognition as a redundancy measure. An aspect of this invention is that its commercial value improves the more that a spectator is rewarded for granting permissions to connect personal information to product placement services.

### Distinction From Region Proposal Methods

Region proposal methods such as those taught in Ren et al., Faster R-CNN: Towards real-time object detection with region proposal networks, IEEE Transactions on Pattern Analysis and Machine Intelligence, 39(6), pp. 1137-1149, 2016, can identify objects within imagery without reference to pre-defined bounding boxes. However, such methods produce detections without any association to specific seat locations, and therefore cannot attribute detected items to a known seat locator, patron identity, ticket purchaser demographic, or physical arena location. The present system uses seat-coordinate-derived bounding boxes from data structure 73 as the primary segmentation unit, ensuring that every detected item is attributed to a specific seat. Region proposal methods may optionally be applied within each seat-defined bounding box by the object recognition and segmentation engine 145 to refine sub-seat detection, but the seat-coordinate segmentation is the foundational step that enables the geolocation and demographic attribution capabilities of the system. In still other embodiments, imagery captured by a camera is segmented into image parts that span multiple seats, and region proposal or other such methods are then employed to recognize objects within said image parts.

### Product Recognition Pipeline

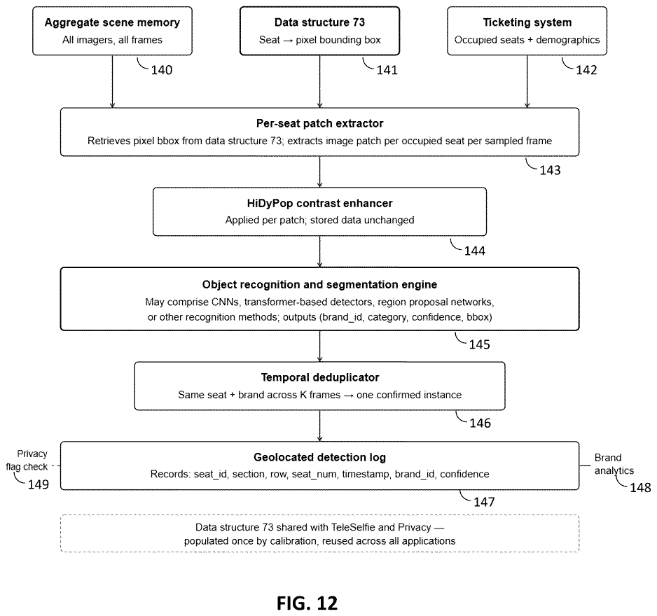

The following pipeline, shown in FIG. 12, is executed on stored imagery, either continuously during the event or in batch after the event:
Step 1—Per-seat patch extractor 143. For each occupied seat (identified from the ticketing system 142) and for each sampled frame at time t (e.g., one frame per two-second interval), the pixel bounding box is retrieved from data structure 73 (141) and the corresponding image patch is extracted from aggregate scene memory 51 (140). In some embodiments, seat occupancy is determined not from the ticketing system 142 but from motion detection within seat bounding boxes in the stored imagery, consistent with the inter-frame motion detection approach described in PCT/US25/61854 for selective storage; in such embodiments, a seat bounding box exhibiting inter-frame motion above a threshold is treated as occupied and its patch is submitted for recognition inference. In some embodiments, patch extraction is triggered by detection of crowd activity events—such as a spike in inter-frame motion energy across a section of the seating area—rather than by periodic sampling, consistent with the event-triggered storage approach described in PCT/US25/61854. The patch is resized to the standard input dimensions of the recognition engine 145 (e.g., 224×224 pixels); in embodiments employing fully convolutional or other variable-input-size recognition architectures, resizing to a fixed dimension may be omitted.
Step 2—HiDyPop contrast enhancer 144. HiDyPop enhancement is applied to each extracted patch before recognition inference, since spectator patches are typically underexposed. The aggregate scene memory 51 is not modified.
Step 3—Object recognition and segmentation engine 145. The enhanced patch is passed through a trained recognition model. The object recognition and segmentation engine 145 may comprise convolutional neural networks, transformer-based detectors, region proposal networks, or other recognition methods. In some embodiments, the confidence threshold applied by the engine 145 is adapted based on scene conditions: for example, a lower threshold may be applied to patches drawn from well-lit seating sections where recognition confidence is generally higher, while a higher threshold may be applied to patches from sections where residual underexposure remains after contrast enhancement, reducing false positive detections. The engine 145 outputs a list of (brand_id, product_category, confidence_score, bounding_box_within_patch) tuples. Detections with confidence scores below a threshold are discarded.
Step 4—Temporal deduplicator 146. If the same seat shows the same brand detection across K or more consecutive sampled frames (e.g., K=3), the detection is counted as a single confirmed instance, preventing artificial inflation of detection counts from stationary spectators. In some embodiments, cross-imager confirmation is used as an alternative or supplementary confirmation mechanism: where the same branded item is independently detected by the object recognition and segmentation engine 145 in patches extracted from two or more different imagers whose fields of view overlap at the same seat location, the detections are cross-referenced using the multi-imager seat coordinate data stored in data structure 73, and agreement between imagers is used to increase the confirmed-detection confidence score above what either single-imager detection alone would yield. This cross-imager confirmation is a direct application of the overlapping field-of-view architecture described in PCT/US25/61854, in which multiple imagers of different focal lengths simultaneously image the same seat region at different subject resolutions.
Step 5—Geolocated detection log 147. Each confirmed detection is logged with the record: {seat_id, section, row, seat_num, timestamp, brand_id, product_category, confidence_score, pixel_bounding_box}. The privacy flag check 149 is applied at this stage: detections corresponding to seats flagged as private in data structure 92 are suppressed from the log. It should be noted that because the obscuring processor 93 applies privacy obscuring before imagery is written to aggregate scene memory 51, imagery of privacy-flagged seats never reaches the per-seat patch extractor 143 in an unobscured state; the privacy flag check 149 at the logging stage therefore serves as a complementary software-layer safeguard to the hardware-level upstream prevention provided by the obscuring processor 93, ensuring that privacy protection is enforced redundantly at both the image capture and the analytics output stages.
Step 6—Brand analytics output 148. Logged detections are aggregated to produce a brand survey report. For example, Nike may learn that 106 instances of its Michael Jordan hoodies were found in a survey of the Rose Bowl football game—78 of them in the University of Oregon sections of the arena, and 28 of them in the Ohio State seating areas.

With adequate training data, the object recognition and segmentation engine 145 can be used not only to identify brands of merchandise but also to identify particular styles or SKUs of items. Imagery of an event can be annotated with location-specific metadata or hyperlinks, permitting customers to browse video or imagery of an event after the fact and identify appealing merchandise worn by spectators or by performers in a concert.

### Module-Level Recognition

In some embodiments, product recognition inference is performed by the convolution circuitry of one or more imaging modules, as described in PCT/US25/61854, executing recognition-oriented filter kernels in parallel with the compression filter kernels described therein. This enables per-seat recognition results to be produced at the imaging module level before pixel data is written to aggregate scene memory 51, reducing central processor load. In such embodiments, the imaging module's processing circuitry applies both a set of compression filter kernels—producing filter result data for storage in the second memory part as described in PCT/US25/61854—and a set of recognition-oriented filter kernels trained to detect branded merchandise patterns, producing per-block detection outputs that are passed to the geolocated detection log 147 without requiring a separate central recognition pass over the full aggregate scene memory 51.

### Hyperlink Annotation

In some embodiments, imagery of an event is annotated with location-specific hyperlinks permitting customers to browse video or imagery of an event after the fact and identify appealing merchandise worn by spectators or performers. For each confirmed product detection, the system stores a record: {frame_timestamp, seat_id, brand_id, product_SKU, purchase_URL, thumbnail_image, pixel_bounding_box}. This record is exposed via a content API enabling post-event browsing experiences in which a viewer can tap on a spectator in the video and receive a link to purchase the identified item. The seat_id field in each record provides the geolocation necessary to associate the tapped video region with the correct product detection record, enabling the content API to resolve tap coordinates in the video frame to the corresponding seat bounding box in data structure 73 and return the associated purchase link.

### Performer Product Placement

The product recognition pipeline, when applied to imaging modules directed at the playing field rather than spectator seating, can detect branded merchandise worn by players or performers. Because the array camera captures the playing field at a subject sampling resolution of at least 1 pixel per 2 mm of subject extent, fine product details such as shoe brand logos (typical size 2-5 cm) are resolvable. Time-stamped performer product detections, cross-referenced with broadcast timestamp data, yield a brand exposure log quantifying seconds of brand visibility within the captured field—a directly monetizable analytics product for brand sponsors. The brand exposure log records, for each detected performer product, the cumulative duration and temporal distribution of detections across the event, enabling brand sponsors to receive quantitative metrics of on-field product visibility comparable to traditional broadcast exposure measurement services.

### Concluding Remarks

Neural networks for object recognition are familiar to artisans and are taught, e.g., in Krizhevsky et al., ImageNet classification with deep convolutional neural networks, Advances in Neural Information Processing Systems, 2012, and in Simonyan et al., Very deep convolutional networks for large-scale image recognition, arXiv preprint arXiv:1409.1556, 2014. Camera calibration methods for projecting world coordinates into image pixel coordinates are taught in Zhang, A flexible new technique for camera calibration, IEEE Transactions on Pattern Analysis and Machine Intelligence, 22(11), pp. 1330-1334, 2000.

The processes and arrangements disclosed in this specification can be implemented as instructions for computing devices, including general purpose processor instructions for a variety of programmable processors, such as microprocessors (e.g., the Intel Core i3, i5 and i9 series, the ARM Neoverse and Cortex series, etc.). These instructions can be implemented as software, firmware, etc. These instructions can also be implemented in various forms of processor circuitry, including programmable logic devices, field programmable gate arrays (such as the Zynq UltraScale+ described in PCT/US25/61854), and application-specific integrated circuits (ASICs).

Implementation can additionally, or alternatively, employ dedicated electronic circuitry that has been custom-designed and manufactured to perform some or all of the component acts, such as an application specific integrated circuit (ASIC), or as an array of hardware logic gates integrated on the same semiconductor as the image sensor.

Software instructions for implementing the detailed functionality can be authored by artisans without undue experimentation from the descriptions provided herein, e.g., written in C, C++, Visual Basic, Java, Python, Tcl, Perl, Scheme, Ruby, Matlab, CUDA, etc., in conjunction with associated data.

Software and hardware configuration data and instructions are commonly stored as instructions in one or more data structures conveyed by tangible media, such as magnetic or optical discs, memory cards, volatile and non-volatile semiconductor memory, etc.

While certain aspects of the technology have been described by reference to illustrative methods, it will be recognized that apparatuses configured to perform the acts of such methods are also contemplated as part of applicant's inventive work. Likewise, tangible computer readable media containing instructions for configuring a processor or other programmable system to perform such methods is also expressly contemplated.

To provide a comprehensive disclosure while complying with the Patent Act's requirement of conciseness, applicant incorporates by reference each of the documents referenced herein in their entireties, even if cited above in connection with specific teachings only.

1. (canceled)

2. A method comprising:
identifying imagery desired by a client from a video memory that stores data for multiple image frames;
determining metrics indicating contrast and image flatness for the identified imagery; and
contrast-enhancing imagery corresponding to at least a sub-region of the identified imagery determined by reference to said contrast and image flatness metrics prior to delivery of said sub-region of imagery to the client;
wherein said data for the multiple image frames stored in the video memory is not altered by said contrast enhancing, but is left in an original state.

3. The method of claim 2 wherein determining metrics indicating image flatness comprises computing, for each of a plurality of tiles of the identified imagery, a high-frequency energy value from a discrete cosine transform of pixel values within the tile, said computation being performed by a tile luminance analyzer.

4. The method of claim 3 wherein contrast-enhancing is applied to a tile only if both a mean luminance of the tile is below a darkness threshold and the high-frequency energy value of the tile is above a texture threshold, said determination being performed by a candidate identifier.

5. The method of claim 2 wherein the contrast-enhancing is applied as a post-interpolation transform within a dual-processor serving pipeline that generates output frames from the video memory, the dual-processor serving pipeline comprising a first processing unit that generates floating-point coordinates for output pixels and a second processing unit that interpolates pixel values from the video memory, the contrast-enhancing being performed by an enhancement stage applied by the second processing unit after interpolation and before delivery to the client.

6. The method of claim 2 further comprising maintaining a per-client enhancement profile recording a history of contrast enhancement parameters applied to that client's output stream, and applying temporal smoothing to the enhancement parameters across consecutive output frames to suppress abrupt changes in enhancement strength.

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A system for dynamic contrast enhancement of spectator imagery, comprising:
a video memory configured to store data for multiple image frames captured by one or more imagers of a camera system, said data being left in an original unmodified state throughout operation of the system;
a first processing unit configured to receive a client-requested view of a sub-part of a scene and generate coordinates for output pixels corresponding to the client-requested view;
a second processing unit configured to compile an output frame from pixel values from the video memory based on the coordinates; and
an enhancement stage coupled to the second processing unit and configured to:
identify at least one sub-region of the output frame, determine metrics indicating contrast and image flatness for said sub-region, and contrast-enhance said sub-region prior to delivery of the output frame to the client, without altering the data stored in the video memory.

27. (canceled)

28. (canceled)

29. (canceled)

30. A system comprising: a video memory configured to store data for multiple image frames captured by a camera system, the data being left in an unmodified state; a serving pipeline configured to concurrently compile, from the data stored in the video memory, a first output frame for delivery to a first client and a second output frame for delivery to a second client, the first and second output frames corresponding to at least partially overlapping regions of a scene represented by the data; and an enhancement stage configured to contrast-enhance at least a sub-region of the first output frame prior to delivery to the first client, while the second output frame is delivered to the second client with a different contrast enhancement than that applied to the first output frame, such that the first and second clients receive independently different enhancement results derived from the same data stored in the video memory, without alteration of the data stored in the video memory.

31. The system of claim 30 wherein the first client comprises a suite viewer application and the second client comprises a broadcast producer application, and wherein the second output frame is delivered to the second client without said contrast enhancement.

32. The system of claim 30 wherein the enhancement stage is further configured to recompute said sub-region of the first output frame independently for each of a plurality of subsequent output frames as a virtual camera position associated with the first client changes.

33. The system of claim 30 wherein the serving pipeline comprises a first processing unit configured to generate floating-point pixel coordinates for the first and second output frames and a second processing unit configured to interpolate pixel values from the video memory to compose the first and second output frames.

34. The system of claim 30 wherein the enhancement stage identifies said sub-region of the first output frame by dividing the first output frame into a plurality of tiles and selecting as candidates for said contrast enhancement only tiles having a mean luminance below a darkness threshold and a high-frequency energy value, computed from a discrete cosine transform of pixel values within the tile, above a texture threshold.

35. The method of claim 2 wherein contrast-enhancing said sub-region comprises computing a scale factor based on a ratio of a target mean luminance to a mean luminance of said sub-region, and iteratively reducing the scale factor if application thereof would cause more than a threshold percentage of pixels in said sub-region to exceed a maximum pixel value.

36. The method of claim 35 wherein contrast-enhancing said sub-region further comprises applying Contrast Limited Adaptive Histogram Equalization to said sub-region instead of or in addition to applying the scale factor.

37. The method of claim 2 further comprising blending, at a boundary of said sub-region, contrast-enhanced pixel values and original pixel values across a feathering band using a linear alpha transition.

38. The method of claim 2 wherein said sub-region is formed by merging a plurality of spatially contiguous tiles flagged as enhancement candidates using connected-component labeling.

39. The method of claim 2 further comprising precomputing enhancement parameters for one or more zones of a venue based on a photometric model of the venue, storing the enhancement parameters in a lookup table keyed by zone identifier and time of day, and initializing said metrics for said sub-region using enhancement parameters retrieved from the lookup table for a zone corresponding to said sub-region.

40. The method of claim 3 wherein the tile luminance analyzer is further configured to prescreen tiles using a luma channel of a chroma-subsampled representation of the identified imagery prior to computing the high-frequency energy value from full-resolution pixel data of a prescreened tile.

41. The system of claim 26 wherein the enhancement stage is further configured to compute a scale factor based on a ratio of a target mean luminance to a mean luminance of said sub-region, and to iteratively reduce the scale factor if application thereof would cause more than a threshold percentage of pixels in said sub-region to exceed a maximum pixel value.

42. The system of claim 26 wherein the enhancement stage is further configured to blend, at a boundary of said sub-region, contrast-enhanced pixel values and original pixel values across a feathering band using a linear alpha transition.

43. The system of claim 26 further comprising a per-client enhancement profile recording a history of contrast enhancement parameters applied to a client's output stream, wherein the enhancement stage is further configured to apply temporal smoothing to the enhancement parameters across consecutive output frames to suppress abrupt changes in enhancement strength.
